(19) United States
(12) Patent Application Publication
(10) Pub. No.: US 2015/0294380 A1
(43) Pub. Date: Oct. 15, 2015

(54) AUTOMATIC BILL ISSUING SYSTEM

(71) Applicant: HITACHI SYSTEMS, LTD., Shinagawa-ku, Tokyo (JP)

(72) Inventors: Kazuya Kikuchi, Shinagawa-ku (JP); Yurie Koga, Shinagawa-ku (JP); Ryosuke Sadakane, Shinagawa-ku (JP)

(21) Appl. No.: 14/431,082

(22) PCT Filed: Sep. 26, 2012
(86) PCT No.: PCT/JP2012/074659

§ 371 Date: Mar. 25, 2015

(51) Int. Cl. G06Q 30/04

(52) U.S. Cl. CPC G06Q 30/04

(57) ABSTRACT

This is an automatic bill issuing system capable of automatically issuing a bill to a user, accepting an application for a formal contract from the user, and enabling the user to use the SaaS service upon issuing the bill of the SaaS service. It includes: a service-selection/number-selection processing unit 211 for accepting selection of SaaS services from a user 100 of the SaaS service; a usage-fee calculation processing unit 212 for calculating a usage fee of the SaaS service that has been accepted by the service-selection/number-selection processing unit 211; a bill issuance processing unit 213 for sending a bill to the user based on the usage fee of the SaaS service calculated by the usage-fee calculation processing unit 212; a formal contract processing unit 214 for accepting an application for the formal contract from the user after confirming bank transfer based on the bill from the user and performing a formal contract processing of the SaaS service; and a SaaS-service usage processing unit 215 for performing a service-usage start processing of the SaaS service after completing the formal contract processing by the formal contract processing unit 214.

### CROSS REFERENCE TO RELATED APPLICATIONS

This application is entitled to the benefit of and incorporates by reference subject matter disclosed in International Patent Application No. PCT/JP2012/074659 filed on Sep. 26, 2012.

### TECHNICAL FIELD

The present invention relates to an automatic bill issuing system for automatically issuing bills and more particularly relates to an automatic issuing process of bills specialized in SaaS service.

### BACKGROUND ART

Conventionally, as technique of automatically issuing bills, there has been an electronic bill management system for collectively managing bills as described in, for example, Japanese Patent Application Laid-Open Publication No. 2002-259900.

### SUMMARY OF THE INVENTION

However, in a conventional technique as described in Patent Document 1, processing of bills related to purchasing of the SaaS service is not considered, and thus there has been a problem of difficulty in using the technique in automatic bill issuing specialized for the SaaS type services.

Also, when purchasing the SaaS service, credit-card payment is mainly used, and there are a large number of companies among which corporate cards are not popular in Japan. Thus, most of the cases are processed with a bill.

In the SaaS services, although there is a function of displaying an estimated fee on the Web in the case of processing with the bill, a sales representative creates the bill to each company in most cases, and therefore, it increases the man hours of the sales.

Accordingly, a preferred aim of the present invention is, in issuance of a bill of a SaaS service, to provide an automatic bill insuring system capable of automatically issuing a bill to a user, and accepting an application for a formal contract from the user, so that the SaaS service is available.

The above and other preferred aims and novel characteristics of the present invention will be apparent from the description of the present specification and the accompanying drawings.

The typical ones of the inventions disclosed in the present application will be briefly described as follows.

More specifically, the typical one of the inventions includes: a service-selection/number-selection processing unit for accepting selection of the SaaS service from a SaaS-service user; a usage-fee calculation processing unit for calculating a usage fee of the SaaS service that is accepted by the service-selection/number-selection processing unit; a bill issuance processing unit for sending a bill to the user based on the usage fee of the SaaS service calculated by the usage-fee calculation processing unit; a formal contract processing unit for accepting an application for a formal contract from the user after confirming a bank transfer from the user based on the bill and performing a formal contract processing of the SaaS service; and a SaaS-service usage processing unit for performing a service usage start processing of the SaaS service after completing the formal contract processing by the formal contract processing unit.

The effects obtained by typical aspects of the present invention disclosed in the present application will be briefly described below.

More specifically, an effect obtained by the typical aspects is to reduce man-hours for bill creation of the sales representative because of automatically issuing the bill to the user, and accepting an application for a formal contract from the user, which leads to promotion of the SaaS service.

### BRIEF DESCRIPTIONS OF THE DRAWINGS

FIG. 1 is a diagram illustrating a configuration and a processing flow of an automatic bill issuing system according to an embodiment of the present invention;

FIG. 2 is a diagram illustrating a customer master used in the automatic bill issuing system according to the embodiment of the present invention;

FIG. 3 is a diagram illustrating a SaaS service master used in the automatic bill issuing system according to the embodiment of the present invention;

FIG. 4 is a diagram illustrating a bill master used in the automatic bill issuing system according to the embodiment of the present invention;

FIG. 5 is a diagram illustrating a contract master used in the automatic bill issuing system according to the embodiment of the present invention;

FIG. 6 is a flowchart illustrating a processing regarding bill issuance of the automatic bill issuing by the automatic bill issuance system according to the embodiment of the present invention; and

FIG. 7 is a flowchart illustrating a processing regarding a formal contract of the automatic bill issuance by the automatic bill issuing system according to the embodiment of the present invention.

### BEST MODE FOR CARRYING OUT THE INVENTION

Hereinafter, embodiments of the present invention will be described in detail with reference to the accompanying drawings. Note that the same components are denoted by the same reference symbols in principle throughout all the drawings for describing the embodiments, and the repetitive description thereof will be omitted.

<Configuration of Automatic Bill Issuing System>

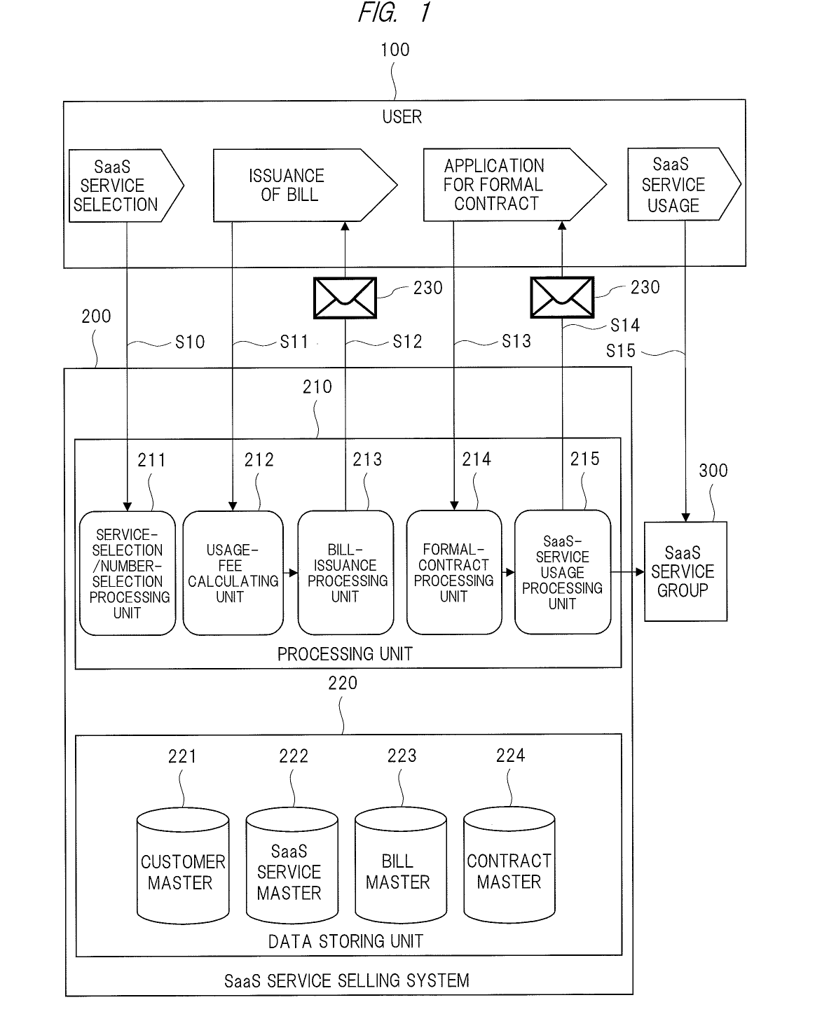

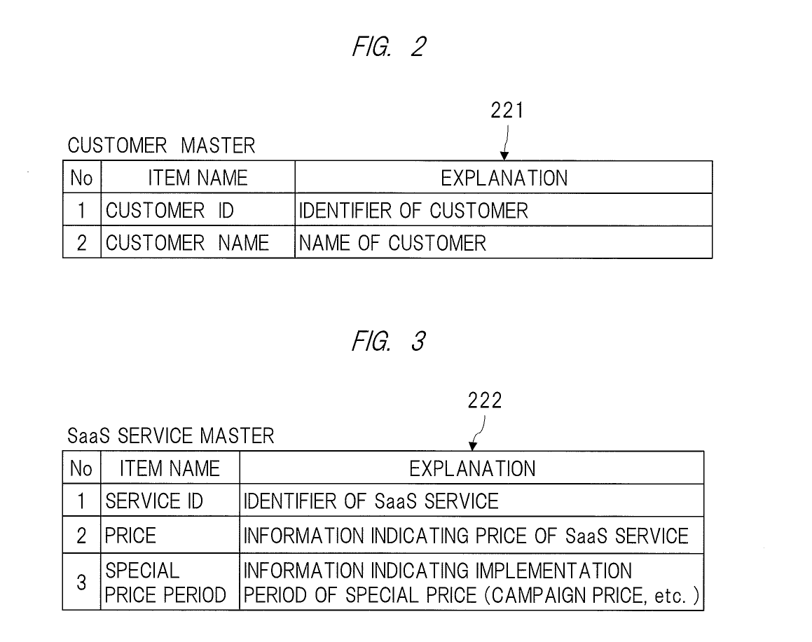

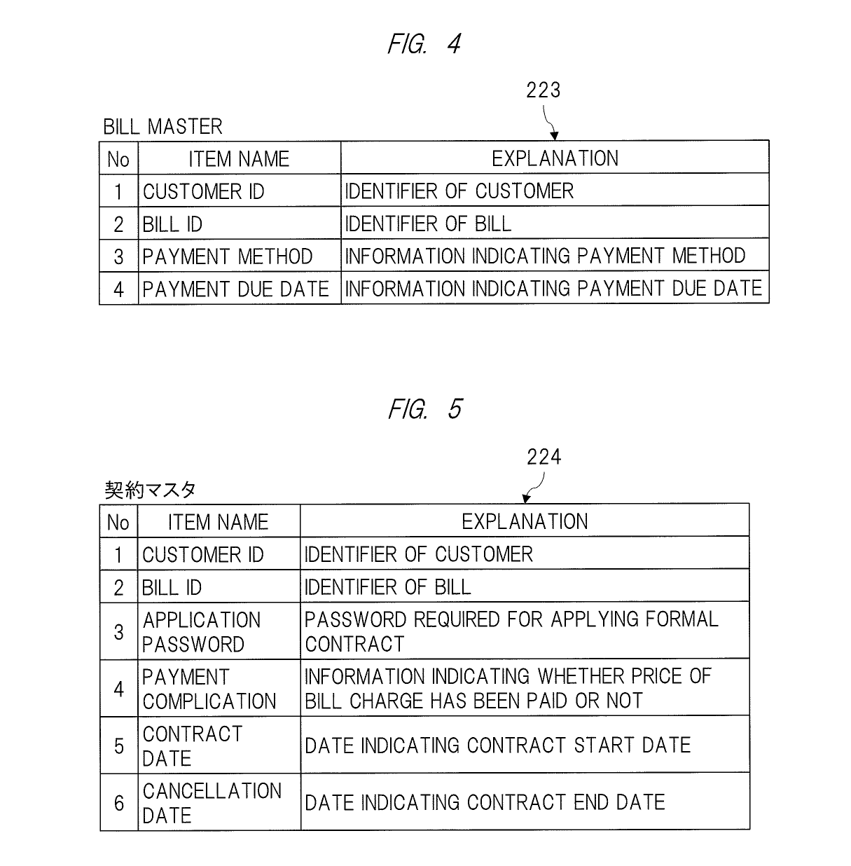

With reference to FIGS. 1 to 5, an automatic bill issuing system according to an embodiment of the present invention will be described. FIG. 1 is a diagram illustrating a configuration and a processing flow of the automatic bill issuing system according to the embodiment of the present invention. FIGS. 2 to 5 are diagrams illustrating information used in the automatic bill issuing system according to the embodiment of the present invention, FIG. 2 illustrates a customer master, FIG. 3 illustrates a SaaS service master, FIG. 4 illustrates a bill master, and FIG. 5 illustrates a contract master.

In FIG. 1, the automatic bill issuing system includes: a SaaS service selling system 200 for selling a SaaS service to a user 100; and a SaaS service group 300 for providing the sold SaaS service. The SaaS service selling system 200 has a processing unit 210 and a data storing unit 220.

The processing unit 210 includes: a service-selection/number-selection processing unit 211 for performing selection of a service/the number of the SaaS service from the user; a usage-fee calculation processing unit 212 for calculating a usage fee of the SaaS service; a bill issuance processing unit 213 for issuing the bill to the user 100; a formal contract processing unit 214 for performing the formal contract of the SaaS service; and a SaaS-service usage processing unit 215 for enabling the user 100 to use the SaaS service.

The data storing unit 220 includes: a customer master 221 in which customer information of the user 100 is stored; a SaaS service master 222 in which information of the SaaS service is stored; a bill master 223 in which information of the bill is stored; and a contract master in which contract information is stored.

As illustrated in FIG. 2, the customer master 221 stores information of a customer ID that is an identifier of a customer for identifying the user and a customer name corresponding to the customer ID as its items.

As illustrated in FIG. 3, the SaaS service master 222 stores as its items, information of a service ID that is an identifier of the SaaS service for specifying the SaaS service, a price that is information indicating a price of the SaaS service, and a special price period that is information indicating an implementation period of a special price (campaign price etc.).

Note that the information of the special price is, for example, included in the information of the price, stored in information of another item as information of the special price, or stored so as to be included in the information of the special price period.

As illustrated in FIG. 4, the bill master 223 stores a customer ID that is an identifier of a customer, a bill ID that is an identifier of a bill, a payment method that is information indicating a payment method, and information about payment due date that is information indicating information of a payment period as its items.

As illustrated in FIG. 5, the contract master 224 stores as its items, a customer ID that is an identifier of a customer, a bill ID that is an identifier of a bill, an application password that is a password required for applying a formal contract, payment completion indicating whether a billed amount has been paid or not, a contract date that is a date indicating a start date of the contract, and a cancellation date that is a data indicating an end date of the contract.

<Summary of Automatic Bill Issuance Processing>

Next, with reference to FIG. 1, the processing of the automatic bill issuance by the automatic bill issuing system according to the embodiment of the present invention will be described.

First, as a summary of the whole processing of the automatic bill issuance, as illustrated in FIG. 1, the user 100 selects, for example, a service which he/she uses from a SaaS service menu displayed by the SaaS service selling system 200 via a network (Step S10).

Here, the user 100 previously sets a password required for applying a formal contract. This password is registered as an application password of the contract master 224.

In addition, information such as a payment method of a usage fee of the SaaS service is also set. This information about a payment method is registered as a payment method in the bill master 223.

In the service-selection/number-selection processing unit 211, a SaaS service to be sold to the user 100 is determined based on selection information from the user 100.

Then, in accordance with a request for issuing a bill from the user 100 (Step S11), the usage-fee calculation processing unit 212 refers to the SaaS service master 222 and calculates a fee from the service selected by the user 100 and from the number of the services.

Then, the bill issuance processing unit 213 creates a bill of the usage fee calculated by the usage-fee calculation processing unit 212, and sends the bill to the user 100 by an e-mail notification 230 (Step S12) to issue the bill to the user 100.

Then, the user 100 requests approval in his/her company based on the bill, applies the formal contract when the request for the approval is passed (Step S13) to perform a formal contract processing by the formal contract processing unit 214.

Here, if the usage fee is not paid by the payment due date shown on the bill, the SaaS service selling system 200 recalculates the usage fee, and reissues the bill.

Note that a reason why the SaaS service selling system 200 recalculates the usage fee here is to confirm whether the usage fee is a set price for a limited period (campaign price etc.) and is a usage fee in only the period or not.

Then, a SaaS-service usage processing unit 215 performs a processing of starting the service usage, sends a service usage notification to the user 100 by an e-mail notification 230 after completing the processing of starting the service usage, and notifies the user 100 that the formal contract is completed (Step S14).

Then, the user 100 who has been notified accesses the SaaS service group 300 and starts the usage of the SaaS service (Step S15).

<Details of Automatic Bill Issuance Processing>

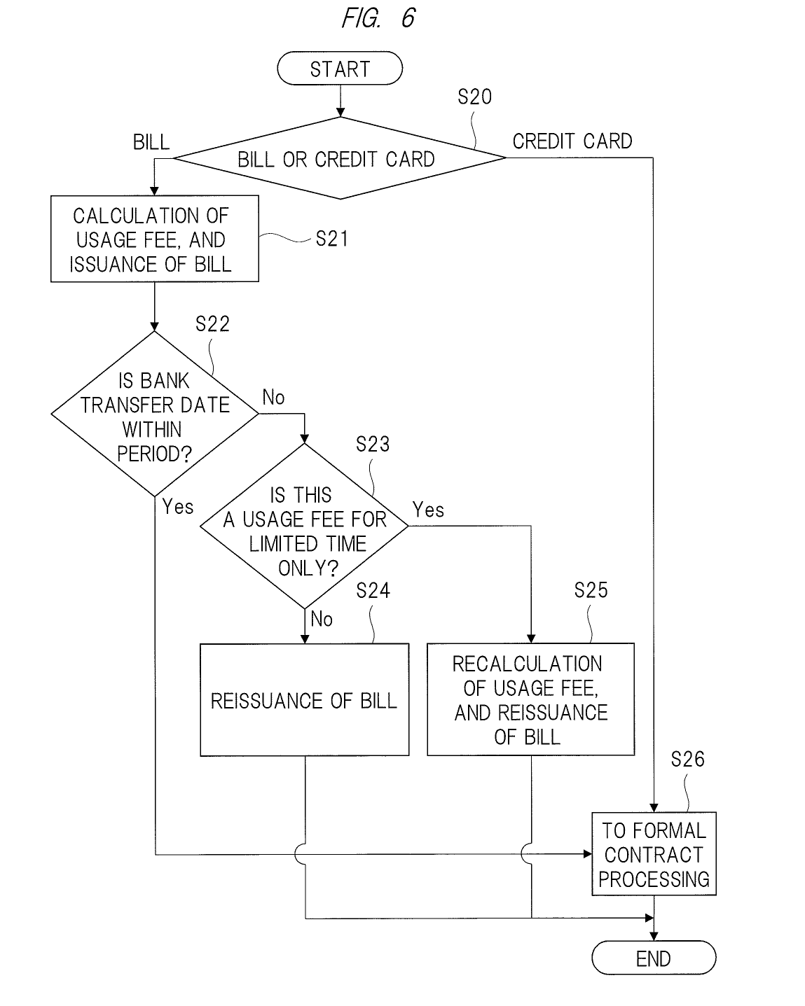

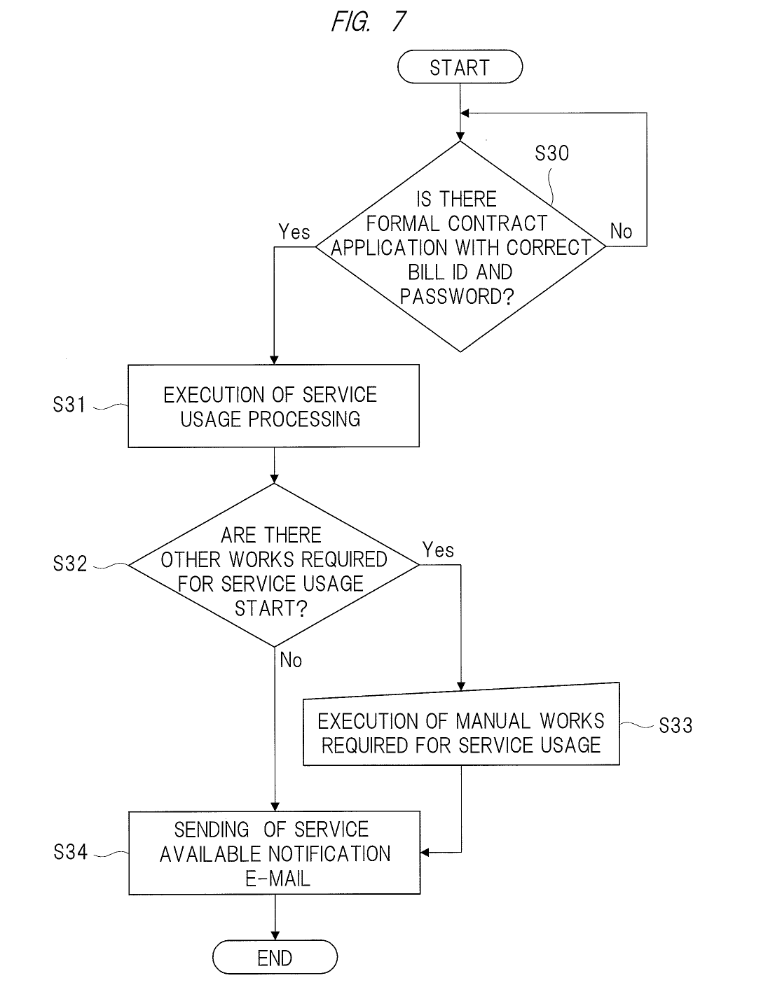

Next, with reference to FIGS. 6 and 7, details of the automatic bill issuance processing of the automatic bill issuing system according to the embodiment of the present invention will be described. FIG. 6 is a flowchart illustrating a processing regarding bill issuance of the automatic bill issuance by the automatic bill issuing system according to the embodiment of the present invention. This flowchart illustrates processings from calculating the service usage fee of the SaaS service which the user has selected to issuing (reissuing) the bill on which the fee is recorded.

FIG. 7 is a flowchart illustrating a processing regarding a formal contract of the automatic bill issuance by the automatic bill issuing system according to the embodiment of the present invention. This flowchart illustrates processings from making the application for the formal contract by the user when the request for the approval is passed on the user's side to completing the formal contract processing and the service usage start processing.

First, as illustrated in FIG. 6, when the selection processing of the SaaS service for the user by the service-selection/number-selection processing unit 211 ends, it is determined with reference to the bill master 223 by which one of the payment with the bill and the payment with a credit card the user pays the fee (Step S20).

When it is determined that the payment is with the credit card in Step S20, the processing directly proceeds to the formal contract processing (Step S26).

In the payment with the credit card, note that, for example, the usage fee is calculated from the selected service contents and is transmitted to a credit company, or the selected service contents are transmitted to the credit company and the payment of the usage fee is settled on the credit company side.

Then, after confirming the completion of the settlement of the payment of the usage fee by the credit company, the formal contract processing is performed.

When it is determined that the payment is with the bill in step S20, the usage fee is calculated from the selected service contents by the usage-fee calculation processing unit 212, and the bill is created and is sent to the user 100 through the e-mail notification by the bill issuance processing unit 213 (Step S21).

Then, it is determined whether the bank transfer for the payment has been made within a due date of the bill or not (Step S22). When it is determined that the bank transfer for the payment has been made within the due date of the bill in Step S22, the processing proceeds to the formal contract processing (step S26).

When it is determined that the bank transfer for the payment has not been made within the due date of the bill in Step S22, it is determined whether the usage fee is the one in the limited period (campaign price etc.) or not (Step S23). When it is determined that the usage fee is not the one in the limited period only in Step S23, the bill is reissued (Step S24), and the processing ends without proceeding to the formal contract processing.

In addition, when it is determined that the usage fee is the one in the limited period only in Step S23, the usage fee is recalculated, the bill is reissued (Step S25), and the processing ends without proceeding to the formal contract processing.

It is determined whether the usage fee is the one in the limited period only or not with reference to the SaaS service master 222 based on a date upon selecting the SaaS service of the user.

After the bill is reissued in Steps S24 and S25, it is determined whether the bank transfer of the reissued bill has been made within the due date in step S22 or no, or a confirmation processing of the bank transfer of the reissued bill is performed, and the formal contract processing is performed after the bank transfer is finally confirmed.

Next, in the formal contact processing, as illustrated in FIG. 7, first, the user 100 inputs a bill ID with which the bank transfer of the usage fee has been completed and the previously-set password on the SaaS service selling system when the request for the approval is passed, so that the formal contract is applied.

The formal contract processing unit 214 determines whether the formal contract has been applied with a correct bill ID and a correct password or not (Step S30). When it is determined that the formal contract has not been applied with the correct bill ID and the correct password, the processing is back to Step S30.

In addition, when it is determined that the formal contract has been applied with the correct bill ID and the correct password in step S30, the application for the formal contract is completed, and then, the service usage processing is executed by the SaaS-service usage processing unit 215 (step S31), and the SaaS-service usage processing unit 215 newly creates user information for using the selected service.

Then, it is determined whether there are other works required for starting the service usage or not (Step S32). When it is determined that there are other works required for starting the service usage in Step S32, manual works required for starting the service usage is performed (Step S33).

When it is determined that there are no other works required for starting the service usage in Step S32 or when the works in Step S33 ends, the created user information, URLs of the services etc., are contained in a service available notification e-mail, and are sent to the user 100 (Step S34), and then, the processing ends.

In the present embodiment, a bill is automatically issued to a user and an application for a formal contract is accepted from the user to make the SaaS service available, so that the man-hours of the sales for creating the bills are reduced, which leads to promotion of the SaaS service.

In the foregoing, the invention made by the present inventors has been concretely described based on the embodiments. However, it is needless to say that the present invention is not limited to the foregoing embodiments and various modifications and alterations can be made within the scope of the present invention.

The present invention relates to an automatic bill issuing system for automatically issuing bills, and is widely applicable to bill issuing processing of apparatuses and systems for providing SaaS type services.

While the present invention has been illustrated and described with respect to a particular embodiment thereof, it should be appreciated by those of ordinary skill in the art that various modifications to this invention may be made without departing from the spirit and scope of the present.

1. An automatic bill issuing system comprising:
a service-selection/number-selection processing unit for accepting selection of a SaaS service from a user of the SaaS service;
a usage-fee calculation processing unit for calculating a usage fee of the SaaS service that has been accepted by the service-selection/number-selection processing unit;
a bill issuance processing unit for sending a bill to the user based on the usage fee of the SaaS service calculated by the usage-fee calculation processing unit;
a formal contract processing unit for accepting an application for a formal contract from the user after confirming bank transfer from the user based on the bill and performing a formal contract processing of the SaaS service; and
a SaaS-service usage processing unit for performing a service usage start processing of the SaaS service after completing the formal contract processing by the formal contract processing unit.

2. The automatic bill issuing system according to claim 1,
wherein, when the bank transfer of the usage fee of the SaaS service from the user cannot be confirmed within a due period of the bill, the bill issuance processing unit reissues a bill, and sends the bill to the user.

3. The automatic bill issuing system according to claim 2, comprising
a SaaS service master in which information of the SaaS service containing information of a special price period of the SaaS service is stored,
wherein the bill issuance processing unit refers to the SaaS service master upon reissuing the bill, and,
when a first bill has been issued within the special price period, the bill issuance processing unit reissues the bill to the user based on the usage fee of the SaaS service recalculated by the usage-fee calculation processing unit.

4. The automatic bill issuing system according to claim 3,
wherein, when a password set by the user so as to correspond to the bill is inputted upon accepting the application for the formal contract from the user, and when the bill and the password are correct, the formal contract processing unit performs the formal contract processing.

5. The automatic bill issuing system according to claim 4,
wherein the bill issuance processing unit sends the bill to the user by e-mail notification.
